(19) United States
(12) Patent Application Publication
(10) Pub. No.: US 2006/0166825 A1
(43) Pub. Date: Jul. 27, 2006

(54) Plant growth promoter

(76) Inventor: David Goulet, Minnetrista, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/045,179

(22) Filed: Jan. 27, 2005

(51) Int. Cl. A01N 63/00

(52) U.S. Cl. 504/117; 424/93.46

(57) ABSTRACT

A plant treatment to improve plant growth and increase yield, the treatment comprising Bacillus megaterium, and methods of making and using the same.

### FIELD OF THE INVENTION

The present invention relates to the field of plant treatments for growth promotion and yield improvement using microbes.

### BACKGROUND OF THE INVENTION

Soil treatments such as soil inoculations with microbes are commonly employed for agricultural uses to promote yields and improve plant quality.

It is known to employ various beneficial microbial organisms or combinations thereof to enhance plant growth. Such micro-organisms include, for example, those from the genera Bacillus, Clostridium, such as Clostridium pasteurianum, Rhodopseudomonas, such as Rhodopseudomonas capsula, and Rhizobiums that fix atmospheric nitrogen; phosphorous stabilizing Bacillus organisms such as Bacillus megaterium; cytokinin producing microorganisms such as Azotobacter vinelandii; and microorganisms from the genera Pseudomonas, such as Pseudomonas fluorescens, Athrobacter, such as Anthrobacter globii, Flavobacterium such as Flavobacteriium sp., Saccharomyces, such as Saccharomyces cerevisiae, and the like. See U.S. Pat. No. 6,311,426, for example.

Microorganisms are often specifically selected for enhancing the growth of particular plants or crops to be grown in the soil and/or to control pathogens which have been found to be present in the soil, i.e. the microorganisms can be readily tailored to the requirements of the soil and the plants or crops to be grown in it. Thus, in a typical case, such microbes promote plant growth for only a limited number of plants or crops.

Rhizobiums, for example, have long been recognized as forming a symbiotic relationship with legumes by host-symbiont recognition and penetration of the root by Rhizobium. Rhizobiums convert atmospheric nitrogen into ammonia (“nitrogen fixation”). Inadequate nitrogen fixation of the plants, especially during the establishment year, could affect stand productivity and long-term persistence. See, for example, U.S. Pat. No. 6,548,289.

Such microorganism are well know and are readily available from public depositories including American Type Culture Collection (ATCC) and Agricultural Research Service Culture Collection (NRRL).

There remains a need in the art for a treatment for promoting plant growth which has a wide range of efficacy for a greater variety of plants.

### SUMMARY OF THE INVENTION

The present invention provides an improved treatment for plants to enhance plant growth containing cultures, suspensions, spores, or cells of bacteria.

More specifically, the present invention relates to a treatment for plants which contain a bacterial culture, suspension, spores or cells of Bacillus megaterium (B. megaterium), and more specifically, the B. megaterium strain currently identified as PM99. Encore Technologies has deposited PM99 with the American Type Culture Collection and an ATCC number is expected in the near future.

The present invention also relates to a method of treating plants. The treatments may be applied to seeds, roots, soil, stems or foliage of plants, or any combination thereof.

B. megaterium plant treatments according to the present invention may either be supplied to end users in a dried powder form, or for easier use, as an aqueous mixture of the bacteria in water.

In one particular embodiment, an aqueous slurry of PM99 is applied to seeds prior to planting. The slurry may be prepared using a dried powder of spores which are mixed in water.

Application of the liquid mixture of PM99 may be accomplished using any suitable means known in the art including spraying, inoculating, mixing, etc. In one embodiment, it is applied to the seeds prior to planting.

PM99 has been found to have a wide range of efficacy and has been found to provide exceptional increases in yield over a very wide range of plants, as opposed to many strains which provide benefit only to a very limited number of plants. The use of PM99 has been found to result in quicker emergence, faster growth, quicker canopy closure preventing sunlight from reaching weeds, each of which results in increased yields.

Any plants may be treated with B. megaterium, strain PM99 according to the invention. However, examples of plants suitable for treatment with B. megaterium, strain PM99 include, but are not limited to, vegetables including legumes, fruits and herbs. The treatment also finds utility on any type of field crop such as soybeans and field corn to mention only a couple.

Other aspects of the invention are described in the Detailed Description and in the claims below.

### DETAILED DESCRIPTION OF THE INVENTION

While this invention may be embodied in many different forms, there are described in detail herein specific embodiments of the invention. This description is an exemplification of the principles of the invention and is not intended to limit the invention to the particular embodiments illustrated.

All published documents, including all US patent documents, mentioned anywhere in this application are hereby expressly incorporated herein by reference in their entirety. Any copending patent applications, mentioned anywhere in this application are also hereby expressly incorporated herein by reference in their entirety.

The present invention relates to a treatment or plant growth promoter containing a rhizosphere bacteria, B. megaterium. The bacteria are capable of stimulating plant growth by releasing nutrients and growth promoters in the soil. The bacteria may be incorporated in the form of cultures, suspensions, spores or cells. In one embodiment, dried spores are employed. Water may be added to the dried spores to form a liquid suspension.

The treatments of the present invention may be applied to seeds, soil or plant foliage to increase plant productivity and quality in agricultural, horticultural, forestry and other applications involving living plants.

The present invention further relates to a method of treating plants. The plants may be treated in a variety of ways including incorporating a liquid slurry into the soil, drenching the soil or existing seedlings, or by treating the seeds of plants with B. megaterium bacteria by applying the bacteria in the form of a slurry such as by spraying the seeds prior to planting or by mixing the slurry with the seeds prior to planting.

The concentration of bacteria suitably is in the range from about 1×10⁵ colony forming units (cfu)/cc (cubic centimeter) of soil to about 5×10⁷ cfu/cc, and more suitably about 5×10⁵ to about 5×10⁶ cfu/cc of soil.

The number of colony forming units/cc of soil employed may depend on a variety of factors including, but not limited to, soil condition, the type of plant being treated, cost-benefit analysis, etc.

In one embodiment, about 2×10⁶ to about 2×10⁷ cfu/cc of soil was found to be beneficial for tomato seedlings, and particularly, in the case of beefsteak tomatoes, about 5×10⁶ cfu/cc of soil was found to be particularly beneficial for the tomato seedlings. In other embodiments, 1×10⁶ cfu/cc of soil was found to be beneficial for broccoli and iceberg lettuce.

Suitably, about 100 grams to about 250 grams of B. megaterium, strain PM99 is added to about 1 gallon (about 4 liters) of water. More suitably, about 0.25 pounds (about 110 grams) to about 0.5 pounds/acre (about 230 grams) is added to 1 galloon (about 4 liters) of water which is then applied on a per acre basis.

These amounts are intended for illustrative purposes only and not as a limitation on the scope of the present invention. Rates of application may vary depending on the type of plant to which the plant treatment is being applied as well as the type of soil, soil conditions and quality of the soil, etc.

Other ingredients may be optionally added to the B. megaterium plant treatments according to the invention. Examples of such optional ingredients include, but are not limited to, natural enzymes; growth hormones; micronutrient elements such as boron, manganese, zinc, copper, iron, molybdenum, etc; water-soluble nitrogen-containing compounds such as sodium and potassium nitrate; water-soluble phosphorus-containing compounds such as calcium phosphates, superphosphates, ammonium phosphates, nitrophosphates, monoorthophosphates such as liquid ammonium polyphosphate; water-soluble potassium-containing compounds such as commercial potash, potassium chloride, camallite, potassium sulfate, potassium nitrate, etc; other nutrients such as water-soluble calcium, magnesium, sulfur compounds, etc.; control agents including pesticides such as acaracides and molluskicides, insecticides, fungicides, nematocides, etc. This list is intended for illustrative purposes only, and does not limit the present invention. Such additives are known to those of skill in the art.

B. megaterium, strain PM99, may also be employed in combination with other types microorganisms such as species of Azospirillum, Rhizobium, other species of Bacillus as well as other megaterium strains, Trichoderma, Saccharomyces, Azo, Chlorella, Streptomyces, Clostridium, Rhodopseudomonas, Azotobacter, Pseudomonas, Athrobacter, Flavobacteriium, etc. to mention only a few. See U.S. Pat. No. 6,311,426, and U.S. Pat. No. 6,471,741, both of which are incorporated by reference herein in their entirey. Such mixtures can result in a synergistic effect on the plant growth.

The plant treatments containing B. megaterium, strain PM99 according to the invention, has been found to have a wide range of efficacy as compared to other types and strains of bacteria which may only have efficacy on one or two different types of plants.

Plant treatments containing B. megaterium, strain PM99 have been found to increase the yield of a variety of plant types by improved germination, quicker stand establishment and faster canopy closure.

The plant treatment according to the invention may be employed on any agricultural plant including field crops, vegetables, fruits, herbs and spices, etc.

The plant treatment may be employed on vegetables including legumes, i.e. pod and seed vegetables. Legumes include the bean group including all field beans such as soybeans, garden beans, etc., the pea group including yellow peas, corn such as sweet corn and field corn, etc.

The present invention finds utility on leafy vegetables such as lettuce. Iceberg lettuce and spinach are only examples of such leafy vegetables on which the treatment containing B. megaterium, strain PM99 may be employed.

Other examples of vegetables on which the present treatment may be employed include, but are not limited to, broccoli, carrots, cauliflower, celery, parsley, etc.

Examples of fruits include, but are not limited to, tomatoes, peppers,

The above list of plants is intended for illustrative purposes only, and not intended to limit the scope of the present invention.

Application of B. megaterium, strain PM99 has been found to increase the yield of crops by as much as about 25%, more typically about 20%.

The B. megaterium, strain PM99 can improve germination resulting in quicker emergence, quicker stand establishment, faster canopy closure, and higher yields. Faster canopy closure can decrease the amount of weed growth.

The invention is further illustrated by the following non-limiting examples.

### EXAMPLES

### Example 1

The yield in bushels/acre was measured for yellow peas grown in Leaf River, Ill., which were untreated, yellow peas treated with 0.25 lbs/acre and yellow peas treated with 0.5 lbs/acre B. megaterium, strain PM99 was measured. A slurry of B. megaterium, strain PM99 in water was prepared by mixing 0.25 lbs and 0.5 lbs in one gallon of water. The slurry was then mixed with the seeds in the planter box. The yellow pea seeds were planted at a rate of 185 lbs/acre in 7.5″ rows on Jun. 5, 2003. The peas were harvested on Oct. 8, 2003. The results are shown in Table 1.

TABLE 1
Results on Yellow Peas treated with B. megaterium, strain PM99

| Seed treatment | Yellow Peas/Yield |
|---|---|
| None | 40 bushels/acre |
| 0.25 lbs/acre | 51 bushels/acre |
| 0.5 lbs/acre | 49 bushels/acre |

The yield of yellow peas was increased by approximately 25% by treating the seeds with B. megaterium, strain PM99 slurry by adding 0.25 lbs of the B. megaterium, strain PM99 to 1 gallon of water and a second slurry by adding 0.50 lbs of the B. megaterium, strain PM99 to 1 gallon of water. There was little visual difference noted between the plants resulting from the addition of 0.25 lbs/acre of the B. megaterium, strain PM99 and 0.50 lbs/acre of the B. megaterium, strain PM99 bacteria. The canopy closed more quickly on the treated plots resulting in additional weed suppression.

### Example 2

A liquid suspension of spores was formed using a concentration of 2×10⁷ spores of B. megaterium, strain PM99 per ml of water. One liter of the liquid suspension was then added to 4000 cc of soil (5×10⁶ spores(cfu)/cc of soil) where tomato seedlings (variety: Beefsteak) were planted. After 30 days, the tomato seedlings treated with the bacteria showed a significant increase in both root and plant growth over untreated tomato seedlings. Table 2 below illustrates the effect of B. megaterium strain PM99 plant treatment on the height of tomato seedlings.

Additionally, the plant treatment was also employed on the tomato variety Hy-Peel which, upon visual inspection, produced a significant beneficial effect after 23 days compared with other bacteria or plain water treatments. These treatments were single applications mixed with potting soil when seeds were sown into greenhouse cavity flats.

The quantitative results of the experiments on Beefsteak tomatoes is shown in Table 2.

TABLE 2
Results on Tomato Seedlings treated
with B. megaterium, strain PM99

| Treatment | Tomato Seedling | Top Fresh | Root Fresh |
|---|---|---|---|
| (cfu/cc of soil) | Height (cm) | wt. (g) | wt. (g) |
| 5 × 10⁴ | 10.6 ± 1.3 | 4.7 ± 1.5 | 1.7 ± 0.8 |
| 5 × 10⁵ | 13.4 ± 0.9 | 5.8 ± 1.0 | 2.3 ± 0.6 |
| 5 × 10⁶ | 15 ± 1.5 | 7.9 ± 1.6 | 2.6 ± 0.7 |
| Control (untreated) | 10.7 ± 1.1 | 5.4 ± 1.2 | 2.7 ± 0.7 |

The greenhouse soil employed was 3 parts of mineral soil and 1 part pearlite by volume. The control was treated with only water. As can be seen from Table 2, a treatment of 5×10⁶ exhibited the most benefit in plant growth.

### Example 3

Broccoli seeds (variety De Cicco) were planted into greenhouse transplant trays containing soil treated with B. megaterium, strain PM99, at 1×10⁶ cfu/cc of soil. The following table illustrates the growth of the plants where the seeds were treated with B. megaterium, strain PM99 versus a control which was watered only. After 30 days, the plants height was measured as well as the fresh weight of the roots and shoots. Table 3 illustrates the results.

TABLE 3
Results on Broccoli treated with B. megaterium, strain PM99

| | Height (cm) | Root Weight (g) | Top Weight (g) |
|---|---|---|---|
| Treatment | Avg of 10 plants | Avg of 50 plants | Avg of 50 plants |
| 1 × 10⁶ | 12 ± 0.9 | 0.19 ± 0.09 | 0.29 ± 0.06 |
| Water control | 9.5 ± 1.3 | 0.15 ± 0.08 | 0.28 ± 0.07 |

As can been seen from the table, treatment with B. megaterium, strain PM99 resulted in a significant increase in plant growth over 30 days.

### Example 4

Lettuce seeds were planted into greenhouse transplant trays containing soil treated with B. megaterium, strain PM99 at a concentration of 1×10⁶ cfu/cc of soil. Visual inspection showed plants with greater leaf size and more aesthetically pleasing color after 20 and 30 days. The top weight of the plants was measured after 30 days. The treated plants were compared to control plants which were given only water. The results are shown in Table 4.

TABLE 4
Iceberg Lettuce treated with B. megaterium

| | Top Weight (g) |
|---|---|
| Treatment | Average of 50 plants |
| 1 × 10⁶ cfu/cc of soil | 0.72 ± 0.02 |
| Water control | 0.37 ± 0.01 |

As can be seen from Table 4, the top weight of the plants was doubled with application of B. megaterium, strain PM99 to iceberg lettuce seeds.

### Example 5 and Comparative Examples A and B

A commercial-scale trial was conducted to determine the efficacy of several beneficial microbial soil incorporation treatments for growth enhancement of vegetable transplants produced in a greenhouse during the cool production cylces on the California Central Coast. Celery seedlings (var. Conquistador®) are important because of a high commercial demand. They are difficult to grow during cool seasons conditions.

Example 1 was a plant treatment containing Bacillus megaterium, strain PM99 according to the invention. Comparative example A was a plant treatment containing a mixture of a different species of Bacillus microorganism and a species of Azospirillum. Comparative example B was a plant treatment containing a mixture of a species of Bacillus microorganism and a Bacillus subtilis microorganism.

100 g of the dry bacteria or mixture of bacterium was added to 5 gallons of water and applied to 50 cubic feet of soil (100 g/50 cu. ft.). Comparative example A was applied at a rate of 2.25 gallons of product/50 cubic feet of soil. The rates were modified due to total water volume (5 gallons or less) variations at application time.

Plant growth assessments were based upon a subjective visual comparison of treatment plants by a team of experts as well as quantitative comparisons (Table 5) to correlate with the qualitative visual assessments.

Visual inspection of plant height, root development and leaf number showed the B. megaterium, strain PM99 to result in superior celery plants over comparative examples A and B.

The wet weight and dry weight of the plants treated with example 5 and comparative examples A and B are shown in Table 5.

TABLE 5
Plant Weight of Celery Treated with B. megaterium

| | Total Wet | Avg. wet | | Avg. Dry | |
|---|---|---|---|---|---|
| | wt. 30 | wt./plant | Std. | wt./plant | Std. |
| Treatment | plants (g) | (g) | Deviation | (g) | Deviation |
| Comp Ex A | 14.31 | 0.477 | 0.11 | 1.860 | 0.1 |
| Comp Ex B | 10.74 | 0.358 | 0.07 | 1.345 | 0.1 |
| Ex. 5 | 17.43 | 0.581 | 0.07 | 2.125 | 0.2 |

As can be seen from Table 5, the plants treated with B. megaterium, strain PM99 (example 5) exhibited the highest wet and dry weight per plant after 51 days. The plants treated with the mixture of Bacillus species, comparative example B, appeared to have an antagonistic effect on the celery growth in these experiments.

The above examples are intended for illustrative purposes only, and not as a limitation on the scope of the present invention.

The above disclosure is intended to be illustrative and not exhaustive. This description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

1. A method of promoting the growth of plants comprising treating the plants with Bacillus megaterium, strain PM99.

2. The method of claim 1 wherein the plants are grown from seeds, the plants comprising roots, stems and foliage, said at least one of said seed, root, stem or foliage is treated with said Bacillus megaterium, strain PM99.

3. The method of claim 1 wherein the plants are grown from seeds, the method comprising treating the seeds with Bacillus megaterium, strain PM99.

4. The method of claim 3, the method further comprising the step of forming an aqueous slurry of Bacillus megaterium, strain PM99.

5. The method of claim 4, the method further comprising the step of adding said slurry to said seeds.

6. The method of claim 5, said adding step consisting of mixing said slurry with said seeds or spraying said seeds with said slurry.

7. The method of claim 1, the aqueous mixture applied at a rate of about 1×10⁵ cfu/cc of soil to about 5×10⁷ cfu/cc of soil.

8. The method of claim 1, the aqueous mixture applied at a rate of about 5×10⁵ cfu/cc of soil to about 5×10⁶ cfu/cc of soil.

9. The method of claim 1 wherein the plants are selected from the group consisting of fruits, vegetables, herbs and field crops.

10. A plant treatment to improve plant growth and increase yield, the treatment comprising Bacillus megaterium, strain PM99.

11. The plant treatment of claim 10 in the form of an aqueous mixture.

12. The treatment of claim 11, the mixture comprising about 1×10⁵ to about 5×10⁷ spores per ml of water.

13. The treatment of claim 1 1, the mixture comprising about 5×10⁵ to about 5×10⁵ spores per ml of water.

14. The plant treatment of claim 11, the treatment comprising about 25 grams to about 75 grams of Bacillus megaterium, strain PM99 per liter of water.

15. A method of planting seeds, the method comprising the steps of:
treating seeds with an aqueous slurry of Bacillus megaterium, strain PM99; and
planting the treated seeds.

16. The method of claim 15, said method further comprising the step of adding a powder of Bacillus megaterium, strain PM99 to water.

17. The method of claim 15 wherein about 100 grams to about 250 grams of Bacillus megaterium, strain PM99 is applied to about 70 kilograms to about 90 kilograms of seeds.

18. The method of claim 17 wherein the seeds are planted on a per acre basis, and about 70 kilograms to about 90 kilograms of seeds are planted per acre.

19. The method of claim 15 wherein about 110 to about 230 grams of Bacillus megaterium, strain PM99 is applied to about 70 kilograms to about 90 kilograms of seeds.

20. The method of claim 19 wherein the seeds are planted on a per acre basis, and about 70 kilograms to about 90 kilograms of seeds are planted per acre.
